(19) United States
(12) Patent Application Publication
(10) Pub. No.: US 2012/0305870 A1
(43) Pub. Date: Dec. 6, 2012

(54) CABLE PULLEY

(75) Inventors: Patricia Ruef, Luechingen (CH); Holger Streitz, Bludenz (AT)

(73) Assignee: LIEBHERR-WERK NENZING GMBH, Nenzing (AT)

(21) Appl. No.: 13/478,798

(22) Filed: May 23, 2012

(30) Foreign Application Priority Data
May 30, 2011 (DE) 10 2011 102 801.7
Jul. 21, 2011 (DE) 10 2011 108 230.5

(51) Int. Cl. F16H 55/48; F16H 55/40

(52) U.S. Cl. 254/390

(57) ABSTRACT

The present disclosure relates to a cable pulley with a circumferentially extending groove for guiding a cable, wherein the cable pulley has a modular design and includes a wheel-shaped carrier body and a ring-shaped groove body, wherein the carrier body is at least partly made of a composite material, optionally a fiber-reinforced plastic material, and wherein the groove body circumferentially surrounds the carrier body and includes the groove.

### CROSS REFERENCE TO RELATED APPLICATIONS

This application claims priority to German Patent Application No. 10 2011 102 801.7, entitled “Cable Pulley,” filed May 30, 2011, and German Patent Application No. 10 2011 108 230.5, entitled “Cable Pulley,” filed Jul. 21, 2011, which are hereby incorporated by reference in their entirety for all purposes.

### TECHNICAL FIELD

This present disclosure relates to a cable pulley with a circumferentially extending groove for guiding a cable, the use of a cable pulley in a crane or an excavator, and a crane or an excavator with at least one cable pulley.

### BACKGROUND AND SUMMARY

Cable pulleys have a wheel-shaped design and in their condition of use are rotatably mounted about their central axis. Along their circumference, they have a standardized groove with a groove base for guiding a cable. In the prior art, they are used to minimize power losses or damages during the deflection of the pull direction of cables. Applications of cable pulleys, for example include the use in the guidance of hoisting cables and pulling cables in cranes and excavators. For guiding several portions of a repeatedly deflected cable, for example for forming a block and tackle, or also for guiding two or more cables running in parallel, several cable pulleys often are combined to one pulley block.

Known cable pulleys typically are fabricated in one part and are made of metal or plastics, for example of PA 6G (cast polyamide) or cast, forged and/or welded steel. These known cable pulleys have, for example, the disadvantage that solid produced plastic pulleys and in particular pulleys made of steel have a high weight. Material savings and the resulting savings in weight would be to the detriment of the stability of the cable pulley, which likewise is undesirable. A complicated fabrication likewise is undesirable for reasons of cost.

The use of rigid materials such as fiber-reinforced plastics likewise is problematic here, since these materials are quickly damaged or destroyed by the rubbing contact with strongly tensioned steel cables.

It is the objective of the present disclosure to provide a constructively simple cable pulley with which a weight reduction can be achieved without having to accept losses in terms of stability and longevity. This objective is reached, in one example, with a cable pulley having a wheel-shaped design and a circumferentially extending groove for guiding a cable. The cable pulley has a modular construction and includes a wheel-shaped carrier body and a ring-shaped groove body. The carrier body is at least partly fabricated of a composite material. The groove body circumferentially surrounds the wheel-shaped carrier body and includes on its outside, i.e., on the side facing away from the carrier body, the groove for guiding the cable.

Due to the material properties of the composite materials, a substantial reduction in weight can be achieved with a consistent or even increased stability and rigidity. Due to the modular design of the carrier body, a sensible use of these materials is ensured. For example, the composite material of the carrier body is not directly connected with the guided cable and therefore cannot be damaged and worn down. This is important in particular because composite materials like fiber-reinforced plastics are relatively easily damaged by shocks, abrasion and the like.

In one embodiment, the cable pulley according to the present disclosure consists of the carrier body and the groove body, so that there is a two-part structure of the carrier body and the groove body.

In one embodiment, the groove for guiding the cable is a trough-shaped recess whose bottom is formed by a so-called groove base. The form of the groove is typically standardized. Alternatively or in addition, the groove can also include or consist of raised structures, such as circumferentially continuous strips or isolated strips distributed over the circumference, which extend along the edges of the circumferential surface and between which a cable can be accommodated, so that the cable slipping off sideways is prevented.

In one embodiment, the cable pulley according to the present disclosure is round, with the carrier body having a round, wheel-shaped design and the groove body assuming the shape of a circular ring.

The term “wheel-shaped design” should mean that the object referred to has the shape of a possibly round cylinder whose height in relation to the radius is small or whose height is smaller than its radius. The term “circumferential surface” refers to the outer surface of this cylinder. “Circumference” or “circumferential” designates the contour of the circumferential surface, an extension on and along the circumferential surface, or resting against and along the circumferential surface. In the representation of this present disclosure, a “cable” is understood to be any oblong, substantially flexible element for transmitting tensile forces, as would be understood by one skilled in the art.

In one embodiment, the radial extension of the ring-shaped groove body in relation to the radial extension of the wheel-shaped carrier body on the cable pulley is small and, for example, comprises less than 20% or less than 10% of the radial extension of the cable pulley.

In one embodiment, the fiber reinforcement comprises or consists of a glass fiber reinforcement and/or a carbon fiber reinforcement and/or an aramide fiber reinforcement. The use of a carbon fiber reinforcement is one example.

In one embodiment, the carrier body and the groove body are fabricated of two different materials.

In one embodiment, the carrier body wholly consists of the composite material and may be fabricated thereof in one piece. This corresponds to a single-cell or monolithic construction. This embodiment also includes such designs in which the carrier body substantially is made of the composite material, but individual components such as grooves, guideways, screws and the like are fabricated of another material. What is important, rather, is the fabrication of all essential structural elements of the composite material. Examples of a holistic fabrication of the carrier body of the composite material include a hollow-chamber construction, a plane load-bearing construction of two or more parallel disks, a truss construction or combinations thereof. One embodiment of a carrier body, which wholly consists of the composite material, comprises a construction in which the carrier body comprises or substantially consists of a corrugated disk, wherein the waves or curvatures extend radially. The disk may be strongly corrugated, i.e., the amplitude of the waves at half the radius is at least as large as the wavelength thereof.

In one embodiment, the carrier body is fabricated hetereogenously or in multicell form, wherein at least a part of the supporting structural elements and/or the basic framework of the carrier body are made of the composite material.

In one embodiment, the carrier body comprises at least two disks of the composite material arranged in parallel. The same, for example, can define a core of another material in a sandwich-like manner, so that the carrier body has a sandwich construction. One embodiment includes exactly two disks defining a core which is not fabricated of the composite material. The core can have the function of a push core, i.e., effect a rigid connection of the individual disks. The core furthermore can serve as spacer in the production and/or during the operation.

Alternatively or in addition, one or more of the disks of composite material can be enclosed in a jacket of another material. The jacket can keep the disks in position, impart additional stability and protect the disks against shocks, weather influences and other mechanical influences from outside.

In one embodiment, the core and/or the jacket are made of a foam material, in particular of a foamed plastic material, an Al/plastic material composite, or another plastic material. Through a skillful choice of material it can be ensured that the core or the jacket hardly causes any additional weight, since a basic stability already is given substantially by the composite material, and the absorption of the normal stress substantially is effected by the disks. Foam materials in particular have the advantage of a comparatively low density.

In one embodiment, at least one of the disks arranged in parallel includes radially extending hollow spokes. The same can be molded from the disk. In the regions between the hollow spokes, cutouts possibly can be present in the disks. In one example, two or all of the disks have hollow spokes. The hollow spokes for example can be symmetrically distributed on the disk in a circumferential direction. Alternatively or in addition, the disks also can have a curved structure in a radial direction.

In one embodiment, the groove body is made of metal or plastic material. Plastic material is selected in some circumstances due to its comparatively lower weight. Examples include polyamide and POM. The groove body is not fiber-reinforced in one example.

On their outside and/or on their inside, the disks of the carrier body can be accommodated in an upper chord and/or a lower chord, which is made of plastics, metal or likewise of a composite material. The choice of material can be effected corresponding to the choice of material for the disks and the groove body, respectively.

In one embodiment, the carrier body circumferentially includes a receptacle for the groove body. For example, this can be a trough-like recess. However, raised structures such as circumferentially continuous strips or ribs or webs distributed over the circumference also are conceivable, which extend along the edges of the circumferential surface and between which the groove body can be accommodated. In one embodiment, the receptacle can be formed at the upper chord of the carrier body. It is conceivable, for example, that the circumferentially extending or distributed webs or ribs represent an integrally fabricated tab of the disks and the bottom of the recess is formed by the upper chord.

In one embodiment, the groove body is substantially sickle-shaped in cross-section. This term should comprise V-shaped, U-shaped and other cross-sections, wherein a surface is enclosed by a strongly convex line and a less strongly concave line. The concave line corresponds to the groove for guiding a cable on the outside of the groove body, and the convex line to the inside of the groove body, which positively and matingly fits into the receptacle of the carrier body.

In one embodiment, the groove body and the carrier body are stationarily arranged relative to each other inside the cable pulley, i.e., not movable or shiftable against each other. This can be effected by a positive connection. For this purpose, the internal radius of the ring-shaped groove body substantially can correspond to the external radius of the wheel-shaped carrier body.

In this embodiment, forces are transmitted between the groove and the carrier body by positive connection. A positive connection as compared to a non-positive connection can be advantageous, for example due to different coefficients of thermal expansion of the materials used for the carrier body and for the groove body. The positive connection, for example, can be achieved by interlocking depressions and protrusions on the groove body and carrier body, for example by bores and trunnions or pins. These structural elements, for example, are located on the inner circumferential surface of the groove body and the outer circumferential surface of the carrier body or, if present, inside the receptacle of the carrier body (for example, inside the depression or on the strips, ribs or webs).

Alternatively or in addition to the positive connection, a non-positive connection such as a frictional connection or an adhesive connection can ensure the firm position of the carrier body and the groove body relative to each other.

In one embodiment, the groove body has an internal radius which is smaller than the external radius of the carrier body or of the receptacle inside the carrier body (edges of the depression or strips, ribs and the like). The groove body thus represents a lost mold and, as far as the lateral fixation is concerned, is retained on the carrier body merely by positive connection. Thus, the groove body can be integrated into the carrier body in a non-demountable and durable way. This is achieved, for example, by an integral design in the construction, wherein, for example, the groove body is provided and enclosed in the composite material when manufacturing the cable pulley. Manufacturing the composite material can be effected, for example, by lamination, wet molding, transfer molding and the like. An additional fixation by clamps, screws, pins and the like is not necessary, whereby the structure of the groove body according to the present disclosure is substantially simplified.

In the condition of use, a cable pulley according to the present disclosure typically is rotatably mounted. For this purpose, the cable pulley in one embodiment can be formed such that along its axis of rotation the carrier body includes a bore in which a pivot bearing is mountable or is mounted. The bore is located in the center of the carrier body, for example, if the carrier body is circular, in the center of the circle. The pivot bearing can be formed as rolling bearing or plain bearing. It can be connected with the carrier body directly or via an intermediate ring. Here as well, a positive connection and/or a non-positive connection is possible.

In one embodiment, the carrier body includes a channel between the bore for the pivot bearing and the circumferential surface, and the groove body includes an opening aligned or connected with this channel. By such a construction, a pivot bearing lying in the bore can be lubricated from the circumferential outer surface of the cable pulley, in that lubricating oil or grease is introduced or pressed into the channel through the opening (for example through a grease gun) and is actively or passively delivered to the pivot bearing. The channel for example can constitute a hose and in one embodiment can extend within the cable pulley in radial direction. The opening can be open or closeable or include a valve. In one embodiment, the opening includes a flush-mounted lubricating nipple or the like.

The present disclosure furthermore relates to the use of a cable pulley according to the present disclosure for guiding and/or deflecting cables, in particular hoisting cables and/or pulling cables of a crane or excavator.

Finally, the present disclosure relates to a crane or excavator with at least one cable pulley according to the present disclosure.

There are also comprised both stationary luffing cranes, such as fast-erecting cranes or top-slewing cranes as well as mobile cranes with a chassis, a body and a crane arm which includes a boom and possibly a strut. The cable pulleys according to the present disclosure are mounted, for example, on the boom, on the tip of the boom or also on stationary parts of the cranes. Stationary parts of the crane comprise, for example, the body of mobile cranes or the tower or bottom of stationary cranes. The cable pulleys serve for guiding pulling cables, for example in the case of an angular adjustment of the boom or for guiding hoisting cables or for deflection in pulling direction.

By using light-weight components such as the cable pulley according to the present disclosure, energy savings are obtained in these machines during their operation and transport. Furthermore, light-weight machines can be used more universally. A weight saving of parts present on the boom in addition directly goes to the benefit of the payload. A particular advantage is obtained in that, due to the lower weight of the cable pulleys, which are attached to the boom, a longer boom can be erected and that in identically constructed machines longer booms can be used, without a larger counterweight being required.

Further details and advantages of the present disclosure can be taken from the following Figures and exemplary embodiments.

### BRIEF DESCRIPTION OF THE FIGURES

FIG. 1 shows an exploded representation of a cable pulley according to the present disclosure.

FIG. 2 shows cross-sectional representations of three different embodiments of a cable pulley according to the present disclosure.

FIG. 3 shows perspective views of two embodiments of a cable pulley according to the present disclosure. The figures are drawn approximately to scale, although other relative dimensions may be used, if desired.

### DETAILED DESCRIPTION

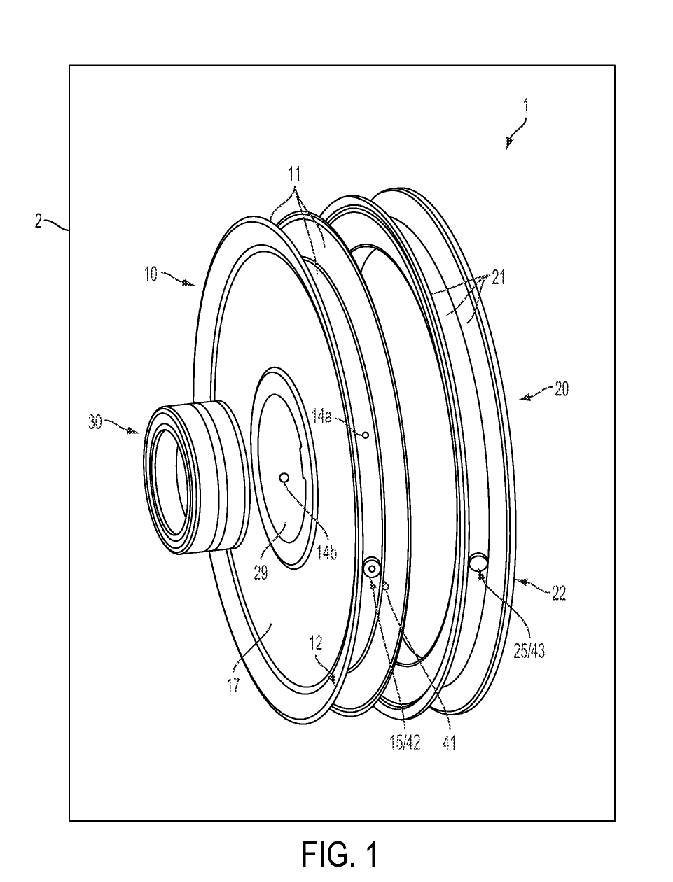

FIG. 1 shows an embodiment of a cable pulley 1 according to the present disclosure in an exploded representation.

The cable pulley 1 includes a carrier body 10 as well as a groove body 20. The carrier body 10 has a wheel-shaped design, wherein a bore 29 is located in the center of the wheel on its axis of rotation. In this bore 29 a pivot bearing 30 is mounted.

The carrier body 10 is formed by two round disks 17 extending parallel to each other, an upper chord 14a and a lower chord 14b. The disks 17 extend from the bore 29 to the circumferential surface of the wheel and represent the lateral boundaries of the carrier body. Between the parallel disks 17 a core or spacer of various materials, for example a push core of a foamed plastic material or a similar rigid connection, can be mounted. Alternatively or in addition, another structure such as a hollow-chamber construction or a truss construction can be located in the space between the disks 17.

Along the two edge regions of the circumferential surface, the carrier body 10 includes a circumferentially continuous strip 12, which in the illustrated embodiment constitutes an extension of the disks 17, which is slightly curved to the outside. Straight extensions are of course also conceivable. The circumferential surface of the carrier body or the upper chord 14a along with the strips 12 forms a trough-like recess which serves as a receptacle for the groove body. In FIG. 1, this receptacle is designated with the reference numeral 11.

In the illustrated embodiment, the disks 17, the upper chord 14a, the lower chord 14b and the strips 12 of the carrier body 10 are fabricated of a carbon-fiber-reinforced plastic material. By this choice of material, a particularly light-weight cable pulley can be manufactured, which nevertheless has a very high mechanical stability and, in particular, rigidity, with the disks 17 absorbing the normal stress.

The groove body 20 is ring-shaped and has a sickle-shaped cross-section. The convex inner jacket surface of this ring positively fits into the receptacle 11 of the carrier body. The ring-shaped groove body 20 thus represents a lost mold for the carrier body 10. On the outer circumferential surface of the ring, a trough-like groove 21 is provided for guiding a cable, which is formed by the bottom of the ring and by the circumferentially continuously extending strips 22. Like the strips 12 of the carrier body, the strips 22 of the groove body also are slightly bent to the outside in the illustrated embodiment, wherein other orientations such as a straight orientation also are comprised by the present disclosure. The groove body is homogeneously fabricated of plastic material. Examples of suitable plastic materials include cast polyamide or POM. In contrast to carbon, the same are insensitive to mechanical shocks.

In the illustrated exemplary embodiment, the connection between the carrier body 10 and the groove body 20, which prevents a displacement around the axis of rotation, is also effected by a positive connection. For this purpose, a trunnion 15 located at the upper chord 14a of the carrier body 10 corresponds with a recess 25 in the bottom of the groove body 20 and thus forms a positive connection which ensures a synchronization of the carrier body and the groove body and prevents a displacement against each other. On the circumference, there can also be a plurality of trunnions 15 and recesses 25 or comparable structures suitable for forming a positive connection. However, this is not shown in the drawing.

The trunnion 15 also serves as a lubricating nipple 42, which is arranged in alignment with an opening 43 in the groove body 20, so that the same is accessible from the groove 21. In the operating condition of the cable pulley according to the present disclosure, even if the same is located in the center of a pulley block, the pivot bearing 30 thus can be lubricated at any time without having to separate the pulley block.

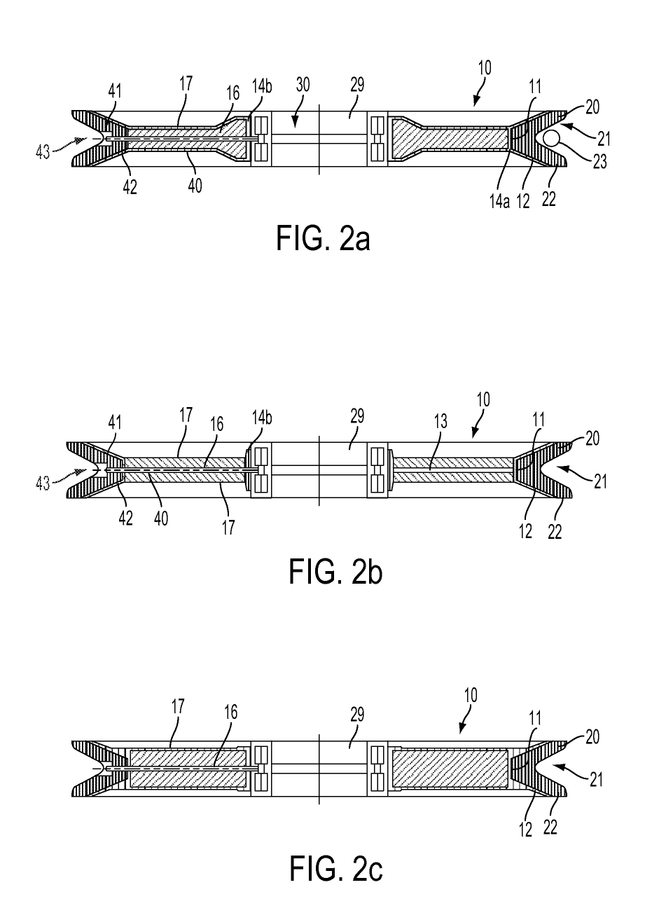

FIG. 2a shows an embodiment of a cable pulley according to the present disclosure in cross-section. In the center, the recess 29 is visible, in which the pivot bearing 30 is located. The same is circumferentially surrounded by the carrier body 10, which in turn is circumferentially surrounded by the groove body 20.

In the embodiment depicted in FIG. 2a, the carrier body 10 is fabricated of two disks 17 arranged in parallel, which include a push core 16. In cross-section, the disks 17 do not appear as a straight line, but are structured in a radial direction, so that the thickness of the carrier body in the edge regions (relative to the radial extension of the carrier wheel) is greater than in the middle region. In the inner and outer end zones close to the upper chord 14a or lower chord 14b, the distance between the two disks 17 widens as compared to the central taper.

The inclusion of the push core 16 ends at the upper chord 14a, so that the end region of the disks 17 appears in the form of two strips 12 protruding from the circumferential edges of the carrier body. Together with the upper chord 14a, these strips form the recess 11 in which a groove body sickle-shaped in cross-section is accommodated. The same in turn includes a trough-shaped groove 21.

In its interior, i.e., between the disks 17, the carrier body 10 includes a radially extending channel 40 which extends from the recess 29 to an opening 42, for example a lubricating nipple. The channel for example can constitute a hose which is embedded in the core material. In the illustrated representation, the opening 42 can be closed by means of a closing means, for example a plug or a cap 41. The opening 42 is aligned with the opening 43 inside the groove body, so that the same is accessible from outside. As described above, this provides lubrication for the pivot bearing 30 inside the bore 29 in the operating condition of the wheel.

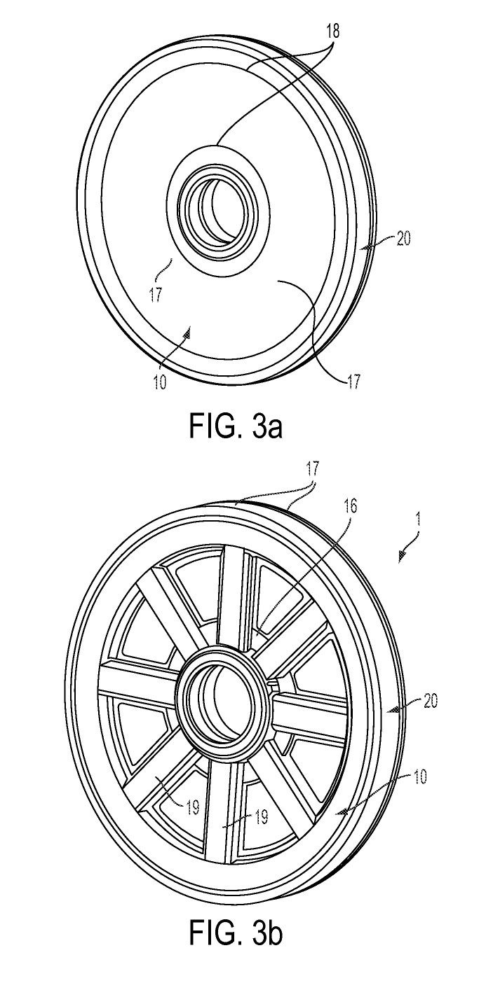

The embodiment of a cable pulley according to the present disclosure as shown in cross-section in FIG. 2a is represented in FIG. 3a in a perspective view. In particular, it is shown there that the disk 17 is structured, wherein the thickness of the cable pulley varies at the points 18. This structuring can include weight savings as well as gains in stability.

A cross-section through a further embodiment of a cable pulley according to the present disclosure is shown in FIG. 2b. Parts corresponding to FIG. 2a are provided with the same reference numeral and will not be described here separately.

An essential difference to the embodiment of FIG. 2a here consists in that the carrier body 10 has a different structure. In this embodiment, the carrier body includes three disks of composite material extending in parallel, of which two disks 17 each represent the outer boundary of the carrier body and a centrally arranged disk 13 serves as an additional reinforcement in the interior. All three disks 13, 17 are fabricated of composite materials. In the spaces between the disks a foam core 16 is disposed.

In further contrast to the embodiment shown in FIG. 2a, the disks 17 are substantially straight in the radial direction, i.e., they have no curved or structured extension in this direction. This applies at least in part.

The embodiment of a cable pulley according to the present disclosure as shown in cross-section in FIG. 2b is represented in FIG. 3b in a perspective view. It can be seen there that the disks 17 have hollow spokes 19 in uniform intervals in the radial direction or are formed to hollow spokes 19, which provide the wheel with an additional stability against an applied normal stress. In the spaces between the hollow spokes 19 there can either be provided a recess, so that the core 16 is visible to the outside, or the disks 17 can be curved such that the spokes represent a mere bulge and the disk is still fabricated without interruption.

FIG. 2c shows a further embodiment of a cable pulley according to the present disclosure in cross-section. The basic structure substantially corresponds to the cable pulleys shown in FIGS. 2a and 2b and identical reference numerals refer to identical parts. These parts will not again be described here in detail.

A particularity of this embodiment again lies in the structure of the carrier body, which in turn includes two parallel disks 17 defining the carrier body to the outside. Similar to the embodiments shown in FIGS. 2b and 3b, the same have molded hollow spokes, which, in contrast to the embodiment shown in FIG. 2b, however, lie in the interior of the carrier body 10 and are embedded in a foam material. Thus, the disks 17 with their spokes or other structurings are not visible to the outside, so that the same are protected against shocks and similar external influences.

1. A modular cable pulley with a circumferentially extending groove for guiding a cable, the cable pulley comprising:
a carrier body; and
a ring-shaped groove body, wherein the carrier body is at least partly made of a composite material, and wherein the groove body circumferentially surrounds the carrier body and includes the groove.

2. The cable pulley according to claim 1, wherein the carrier body is heterogeneous, and wherein supporting structural elements and/or a framework of the carrier body are made of the composite material.

3. The cable pulley according to claim 1, wherein the carrier body comprises at least two disks of the composite material arranged in parallel, together defining a core of another material in a sandwich-like manner.

4. The cable pulley according to claim 1, wherein the carrier body comprises at least two disks of the composite material, one or more of which is enclosed in a jacket of another material.

5. The cable pulley according to claim 3, wherein the core is made of a foam material.

6. The cable pulley according to claim 4, wherein the jacket is made of a foam material.

7. The cable pulley according to claim 3, wherein at least one of the disks arranged in parallel includes radially extending hollow spokes and includes cutouts in regions between the hollow spokes.

8. The cable pulley according to claim 1, wherein the groove body is made of a plastic.

9. The cable pulley according to claim 1, wherein the carrier body circumferentially includes a receptacle for the groove body.

10. The cable pulley according to claim 9, wherein the groove body is sickle-shaped in cross-section and is formed as a lost mold with regard to the receptacle in the carrier body.

11. The cable pulley according to claim 1, wherein the groove body and the carrier body are stationarily arranged relative to each other inside the cable pulley and are positively connected.

12. The cable pulley according to claim 1, wherein the groove body is inseparably integrated in the carrier body.

13. The cable pulley according to claim 1, wherein along its axis of rotation the carrier body includes a bore in which a pivot bearing is mountable.

14. The cable pulley according to claim 13, wherein the carrier body includes a channel between the bore and a circumference of the body, and the groove body includes an opening connected with the channel.

15. The cable pulley according to claim 1, wherein the composite material includes a fiber-reinforced plastic material, and wherein the ring-shaped groove body has an outer face in face-sharing contact with an inner face of the carrier body.

16. The cable pulley according to claim 1, wherein the cable pulley is positioned in a crane or excavator and is coupled with a hoisting and/or pulling cable.

17. A modular cable pulley with a circumferentially extending groove for guiding a cable, the cable pulley comprising:
a carrier body; and
a ring-shaped groove body, wherein the carrier body is at least partly made of a composite material, and wherein the groove body circumferentially surrounds the carrier body and includes the groove, the ring-shaped groove body having a central axis aligned with a central axis of the carrier body, the carrier body made of a different material than the ring-shaped groove body, and wherein the composite material of the carrier body is not directly adjacent to the cable and not contactable with the cable.

18. The cable pulley according to claim 17, wherein the cable pulley is solely a two-part structure.

19. The cable pulley according to claim 18, wherein the groove body is not fiber-reinforced.
